(19) United States
(12) Patent Application Publication
(10) Pub. No.: US 2024/0277178 A1
(43) Pub. Date: Aug. 22, 2024

(54) BEVERAGE FILTRATION AND DRINKING APPARATUS

(71) Applicant: Pacific Market International, LLC, Seattle, WA (US)

(72) Inventors: Stephen James LAKE, Bremerton, WA (US); Graham CORNWELL, Seattle, WA (US); Jesse SERAFIN, Seattle, WA (US)

(21) Appl. No.: 18/170,827

(22) Filed: Feb. 17, 2023

(51) Int. Cl. A47J 31/20; A47J 31/44

(52) U.S. Cl. CPC A47J 31/20; A47J 31/446

(57) ABSTRACT

The disclosed beverage apparatus is configured to allow a user to add a beverage precursor and liquid to a container, separate the liquid from the precursor with a plunger, and consume the separated liquid directly from the same container. In certain implementations, the beverage apparatus includes a screen or filter configured to separate the particulates from the prepared liquid beverage. The beverage apparatus also may include a plunger having one or more valves that are configured to provide a first flow path for the prepared liquid beverage when the plunger is sliding in a first direction and that are further configured to seal to prevent prepared liquid beverage from remaining in contact with the filtered-out particulates. The valves may be additionally configured to provide a second flow path that enables easy removal of the plunger from the container.

### BACKGROUND

A so-called “French press” is used to prepare coffee by separation of the coffee grounds from the prepared coffee liquid during brewing. Liquid that remains in contact with the coffee grounds for too long may cause undesirable flavor characteristics (for example, bitterness from over-brewed coffee). As such, it may be desirable to pour the coffee from the press soon after the brewing process ends.

### SUMMARY

The present disclosure relates to a beverage apparatus that allows a user to separate a particulate matter from a liquid (for example, coffee grounds, loose leaf tea/herbal tincture, or other undesirable particulates) in a beverage container and drink the resulting liquid from the beverage container. The disclosed beverage container includes, in some examples, one or more valves and gaskets that may minimize or prevent the resulting liquid from coming into further contact with the particulates. In some examples, the one or more valves provide flow pathways for the liquid to move through, to facilitate the separation of the particulates and to facilitate disassembly of the beverage container.

In accordance with aspects of the disclosure, a plunger for a beverage container, includes: a base defining a flow passage; a rod connected to the base; gasket disposed about a perimeter of the base; and a valve system connected to the base and disposed at least partially within the flow passage, wherein the valve system includes: a first valve comprising a first flexible portion selectively deflectable away from the base, from a first valve flow-closed condition to a first valve flow-open condition; and a second valve comprising a second flexible portion, wherein the second flexible portion is selectively openable from a second valve flow-closed condition to a second valve flow-open condition.

In an aspect, the plunger additionally includes a screen disposed adjacent the base.

In an aspect, the valve system is removably connected to the base.

In an aspect, the valve system further includes a detent for removably connecting the valve system to the base.

In an aspect, the first valve forms a seal against the base when the first flexible portion is in the first valve flow-closed position.

In an aspect, the base is circular, and at least a portion of the first valve defines an edge at least partially concentric with the perimeter of the base.

In an aspect, the second valve further includes a pair of centrally-disposed flexible lips.

In an aspect, the valve system includes a single first valve and a plurality of second valves.

In an aspect, the first valve and the second valve comprise a unitary part.

In an aspect, the first flexible portion includes at least one flexible flap, wherein the at least one flexible flap circumscribes the valve receiver, and wherein the base includes a plurality of flow-through openings disposed below the at least one flexible flap.

In accordance with aspects of the disclosure, an apparatus includes: a beverage container comprising a sidewall comprising an inner surface at least partially defining an interior container volume; and a plunger slidingly disposed in the interior container volume, comprising: a base defining a flow passage; a rod connected to the base; a gasket disposed about a perimeter of the base, the gasket forming a seal against an inner surface of the sidewall; and a valve system connected to the base and disposed at least partially within the flow passage, wherein the valve system includes: a first valve comprising a first flexible portion selectively deflectable away from the base, from a first valve flow-closed condition to a first valve flow-open condition; and a second valve comprising a second flexible portion, wherein the second flexible portion is selectively openable from a second valve flow-closed condition to a second valve flow-open condition.

In an aspect, the beverage container further includes an outer surface, the outer surface and inner surface defining an insulating volume therebetween.

In an aspect, the gasket includes a pair of flexible protrusions in slidable contact with the inner surface of the sidewall.

In an aspect, the apparatus additionally includes a perforated plate having a first opening configured to allow passage of the rod, the perforated plate being removably connected to an upper end of the beverage container; and a filter supported by the perforated plate.

In an aspect, the perforated plate is configured to slidably receive the rod and is further configured to center the rod within the beverage container, and wherein the perforated includes a plurality of second openings configured to allow the passage of fluid.

In an aspect, during a first sliding movement of the plunger, the first flexible portion of the first valve is deposed in the first valve flow-open position, and the second flexible portion of the second valve is disposed in the second valve flow-closed position, wherein during a second sliding movement of the plunger, the second flexible portion of the second valve opens into the second valve flow-open position, and the first flexible portion of the first valve is deposed in the first valve flow-closed position, and wherein during a still position of the plunger, the first flexible portion of the first valve remains in the first valve flow-closed position, and the second flexible portion of the second valve remains in the second valve flow-closed position.

In an aspect, the first flexible portion of the first valve deflects away from the base when the first flexible portion of the first valve is deposed in the first valve flow-open position.

In an aspect, the second flexible portion includes a pair of lips, and wherein the pair of lips form a seal when the second flexible portion is deposed in the second valve flow-closed position.

In an aspect, the wherein the second flexible portion includes a pair of lips, and wherein the pair of lips deflect away from each other when the second flexible portion is in the second valve flow-open position.

In an aspect, the first flexible portion of the first valve forms a seal against the base when the first flexible portion of the first valve is deposed in the first valve flow-closed position.

In an aspect, the apparatus additionally includes a cap, wherein the cap is removably connected to an upper end of the beverage container, and wherein the cap forms a leak-proof seal around a perimeter of the sidewall.

In accordance with aspects of the disclosure, a method includes: placing a liquid into a beverage container; securing a plunger system to the beverage container; sliding the plunger in a first direction, causing: a first flexible portion of a first valve to deflect away from a base into a first valve flow-open position, and a second flexible portion of a second valve to be deposed in a second valve flow-closed position, the second flexible portion comprising a pair of lips, wherein the pair of lips form a first seal when the second flexible portion is in the second valve flow-closed position; and sliding the plunger in a second direction, causing: the second flexible portion of the second valve to open into a second valve flow-open position, wherein the pair of lips deflect away from each other when the second flexible portion is in the second valve flow-open position, and the first flexible portion of the first valve to form a second seal against the base into a first valve flow-closed position.

In an aspect of the method, the first flexible portion and the second flexible portions, when in their respective first valve flow-open position and second valve flow open position, are configured to allow the passage of liquid.

In an aspect, the method additionally includes prior to securing the plunger system to the beverage container, placing a beverage precursor into the beverage container.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a top perspective view of a beverage filter apparatus, according to an example.

FIG. 2 illustrates a top perspective exploded view of components of the beverage filter apparatus of FIG. 1, according to an example.

FIG. 3 illustrates a top perspective view of the beverage filter apparatus of FIG. 1, showing a plunger partially inserted into a container, according to an example.

FIG. 4 illustrates a top perspective exploded view of a plunger, according to an example.

FIG. 5 illustrates a bottom perspective exploded view of a plunger, according to an example.

FIG. 6 illustrates a top view of an example plunger base, according to an example.

FIG. 7 illustrates a bottom view of an example plunger base, according to an example.

FIG. 8 illustrates a top view of an example valve system, according to an example.

FIG. 9 illustrates a bottom view of an example valve system, according to an example.

FIG. 10 illustrates a top perspective view of a drinking assembly, according to an example.

FIG. 11 illustrates a bottom perspective view of a drinking assembly, according to an example.

FIG. 12 illustrates a cross-sectional view of the drinking assembly, according to an example.

FIG. 13 illustrates a cross-sectional view of the plunger inserted into the beverage container, showing the plunger moving in a downward direction and showing first valves in an open position and second valves in a closed position, according to an example.

FIG. 14 illustrates a cross-sectional view of the plunger inserted into the beverage container, showing the plunger in a stationary position and showing the first valves in a closed position and the second valves in a closed position, according to an example.

FIG. 15 illustrates a cross-sectional view of the plunger inserted into the beverage container, showing the plunger moving in an upward direction and showing the first valves in a closed position and the second valves in an open position, according to an example.

FIG. 16 illustrates a method for separating particulate matter from a liquid, according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. The following detailed description is therefore not to be taken in a limiting sense, and the scope of the present disclosure is defined by the appended claims and their equivalents.

A user may have a desire to prepare a beverage that requires that a particulate be separated from a liquid. For example, preparation of coffee may require separation of the coffee grounds from the prepared coffee liquid after brewing (for example, as in a French press). In another example, preparation of tea or an herbal tincture may require separation of tea leaves/herbal particulates from the prepared tea/tincture liquid after steeping. In another example, purification or filtration of a beverage such as water may require the separation of undesired particulates from the liquid. Further examples of other liquids and particulates are contemplated.

The user may also wish to drink their prepared beverage on-the-go, without needing to pour the prepared beverage into a different drinking container. In certain examples, the disclosed beverage apparatus is configured to allow a user to add a beverage precursor (particulate) and liquid to the container, separate the liquid from the precursor with a plunger, and consume the separated liquid directly from the same container.

In certain implementations, the beverage apparatus may include a screen or filter, configured to separate the particulates from the prepared liquid beverage. In certain implementations, the beverage apparatus (in some examples, a plunger of the apparatus) includes one or more valves that are configured, at least in part, to provide a first flow path for the prepared liquid beverage when the plunger is sliding in a first direction. The one or more valves form a seal to prevent prepared liquid beverage from remaining in contact with the filtered-out particulates (for example, through the perforated surface of the screen). Further, this allows the user to drink from the container over time, without the beverage therein acquiring such undesirable characteristics. The valves may also be configured to provide a second flow path that enables easy removal of the plunger from the container (e.g., moving the plunger in a second direction).

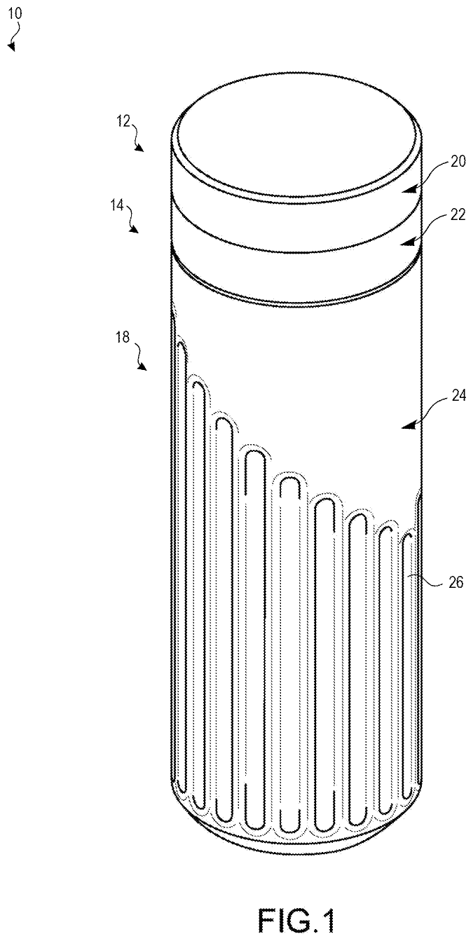

FIG. 1 illustrates a top perspective view of an example beverage apparatus 10. Beverage apparatus 10 may include a cap 12, a drinking assembly 14, and a beverage container 18. Beverage container 18 may include an external surface 24 that may be smooth or textured in whole or in part. In some examples, external surface 24 includes a texture, pattern, ribs, indents, or other surface feature 26 that may improve friction so as to make the beverage container easy to grip. In some examples, beverage container 18 is cylindrical with a round cross-sectional profile, but other cross-sectional profile shapes are contemplated, such as oval, square, squircle, etc. The drinking assembly 14 is disposed adjacent the container 18 and may include an external surface 22 that may be visible when the drinking assembly 14 is attached to the beverage container 18. In another example, the external surface 22 of the drinking assembly may be partially or completely obscured by the beverage container or cap (described below). In such configurations, the drinking assembly 14 may be recessed in either or both of the container and/or cap, which may improve aesthetics, cleanliness, etc. The cap 12 may be configured to be removably attached to the drinking assembly 14. In alternative examples, the cap 12 may be configured to be removably attached to the beverage container 18, and such a configuration may obscure or otherwise cover the drinking assembly 14, as described above. The cap 12 may have an outer surface 12 that is visible when the cap 12 is attached and may also include surface features or textures to enhance removability.

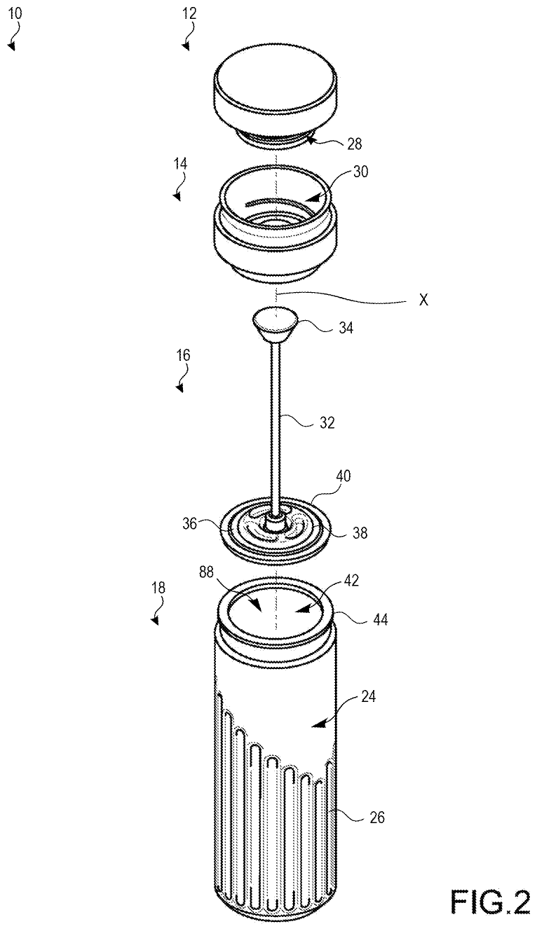

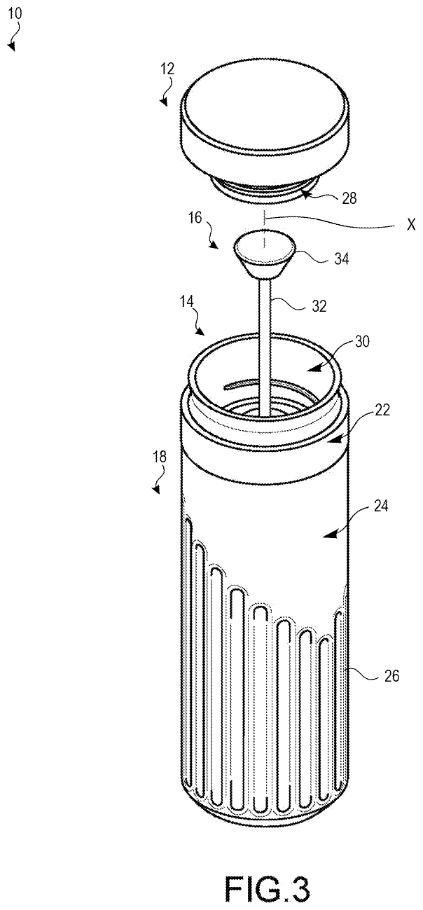

FIG. 2 illustrates a top perspective exploded view of the beverage apparatus 10, which is exploded along an axis X. FIG. 3 illustrates a top perspective exploded view of components of the beverage apparatus 10, showing the drinking assembly 14 connected to an upper end of the beverage container 18, with the cap 12 exploded away from the drinking assembly 14, and a plunger 16 partially inserted into a container. FIGS. 2 and 3 are described concurrently and not all components described are visible in both FIG. 2 and FIG. 3.

Beverage container 18 may include a sidewall 84 having an inner surface 42, the inner surface 42 least partially defining an interior container volume 88. Interior container volume 88 may be configured to hold a liquid and particulates. Beverage container 18 may include a connection portion 44 (e.g., a threaded connection, a press-fit connection, a bayonet-slot connection, etc.) that is configured to removably attach the beverage container 18 to the drinking assembly 14. Drinking assembly 14 may include an inner wall 30 that is configured to removably connect to a cap 12. Cap 12 may be configured to form a seal with the drinking assembly 14 when connected, and to prevent liquid from leaking or spilling out of the beverage apparatus 10. In some examples, drinking assembly 14 and cap 12 may be removably connected by threaded connections (for example, on inner wall 30), snap-fit connections, press-fit connections, or other suitable sealable connections. In examples, the type of connection utilized between the cap 12 and drinking assembly 14 and the drinking assembly 14 and beverage container 18 may be of the same type or of different types. In other examples, engagement of the two connections may be in opposite directions (e.g., a counterclockwise thread between the cap 12 and drinking assembly 14 and a clockwise thread between the drinking assembly 14 and beverage container 18). Plunger 16 may be configured to be slid into and out of the interior container volume 88 (is slidingly disposed within container volume 88) along axis X. In some examples, plunger 16 can be removed entirely from the beverage container 18, e.g., for cleaning purposes. Plunger 16 may be actuated by a user gripping a handle 34 so as to move a rod 32. In some examples, rod 32 may be cylindrical, rectangular, square, hexagonal, or other suitable geometry in cross-section. The handle 34 may be removable or separable from the rod 32 at an end thereof. A user may utilize handle 34 to move the plunger 16 into, out of, and up within, and/or down within the interior container volume 88. In some examples, handle 34 may be cylindrical, frustoconical, conical, or other suitable shape. Disposed opposite the handle 34 is a plunger base 36. Base 36 may be connected to a second end (for example, a lower end) of rod 32. Base 36 may define one or more flow passages, e.g., openings within the base 36. Base 36 may be circular, and/or its shape may be the same shape as the cross-section of beverage container 18.

When the drinking assembly 14 is connected to an upper end of the beverage container 18 as shown in FIG. 3, the handle 34 attached to rod 32 may be configured to extend at least partially above the drinking assembly 14, while the base 36 is positioned below drinking assembly 14. A user may push the plunger 16 downward within the interior container volume 88 (for example, via handle 34) and pull the plunger 16 upward within the interior container volume 88 (for example, via handle 34).A valve system 38 is configured to fit within the one or more flow passages defined in the base 36. All or part of the valve system 38 may be disposed at least partially within the one or more flow passages defined by the base 36. Valve system 38 may be removably connected to the base 36.

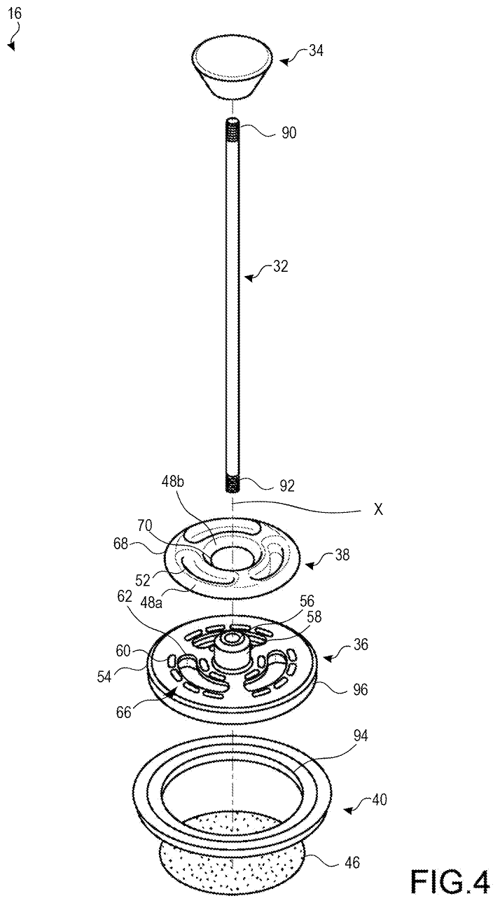

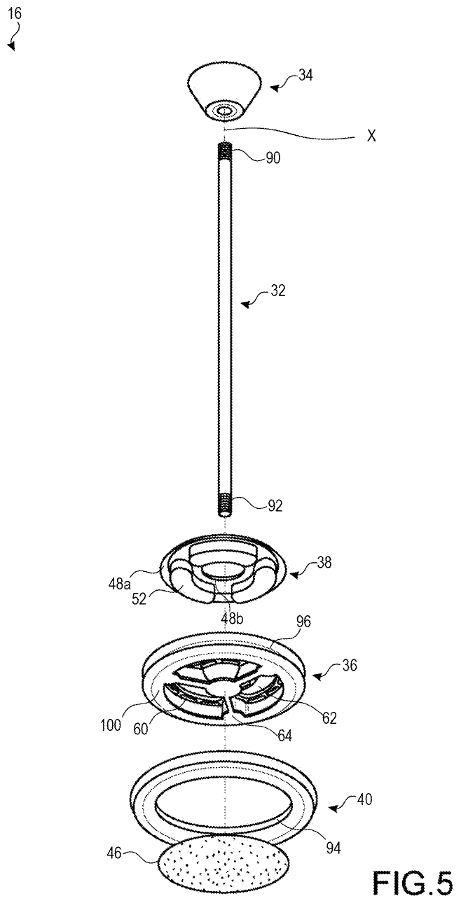

FIG. 4 illustrates a top perspective exploded view of an example plunger 16. FIG. 5 illustrates a bottom perspective exploded view (exploded along axis X) of an example plunger 16. FIGS. 4 and 5 are described concurrently and not all components described are visible in both FIG. 4 and FIG. 5. Rod 32 may be connected at a first end to handle 34. Handle 34 and rod 32 may include features to facilitate a removable connection with rod 32, such as mating threads 90. Rod 32 may be connected at a second end to base 36 at a rod-to-base connection feature 58 that in examples, may be a female threaded connection. Rod-to-base connection feature 58 and rod 32 may include features such as threads 92 to facilitate a removable connection with rod 32.

Base 36 may define one or more first flow passages, including flow through openings 60 and valve receiver 62. Valve system 38 may be carried with base 36, such that an outer perimeter 68 of the valve system 38 is concentric with the outer perimeter 54 of the base 36. Inner perimeter 70 of valve system 38 may be configured as an opening to surround rod-to-base connection feature 58, and to allow rod 32 to pass therethrough. Valve system 38 may include one or more valves, including one or more first valves 48 and one or more second valves 52. First valve(s) 48 and the second valve(s) 52 may be formed of a unitary part, for example, the valve system 38.

In various examples, the first valve 48 may define one or two flexible portions that at least partially form a flow-through path when open. The depicted example includes two such portions (outer portion 48a and inner portion 48b). Outer portion 48a of first valve 48 may include a substantially circular, flexible flap that at least partially circumscribes the outer perimeter 68 of the valve system 38 (and also at least partially circumscribes the one or more vale receiver(s) 62). Outer portion 48a of first valve 48 may sit above flow through openings 60. Inner portion 48b of first valve 48 may include a substantially circular, flexible flap that at least partially circumscribes the inner perimeter 70 of the valve system 38. Inner portion 48b of first valve 48 may sit above flow through openings 60. Each of the one or more second valves 52 may fit within and be the same shape as each of the valve receivers 62. Gasket 40 may be carried with base 36 and may include an inner portion 94 that engages with and is concentric with a gasket receiving groove 96 of base 36, where the gasket receiving groove 96 circumscribes the outer edge of base 36. Gasket 40 may comprise a flexible material such as silicone, rubber, or other suitable material or combination of materials.

Screen 46 may be carried with base 36. In some examples, screen 46 may comprise a woven or perforated plate or disc comprising a metal, polymer, or other suitable material. In other examples, screen 46 may comprise a porous material such as a polymer filter or paper filter. The openings or perforations of screen 46 may be configured so as to allow a suitable flow of liquid to pass therethrough, while preventing passage of coffee grounds or other beverage precursors or particulates. Screen 46 may be disc-shaped and have a smaller circumference than that of base 36. Screen 46 may be supported by one or more radial spokes 64 on a bottom surface of base 36 (a surface opposite the upper surface of base 36 that carries valve system 38).

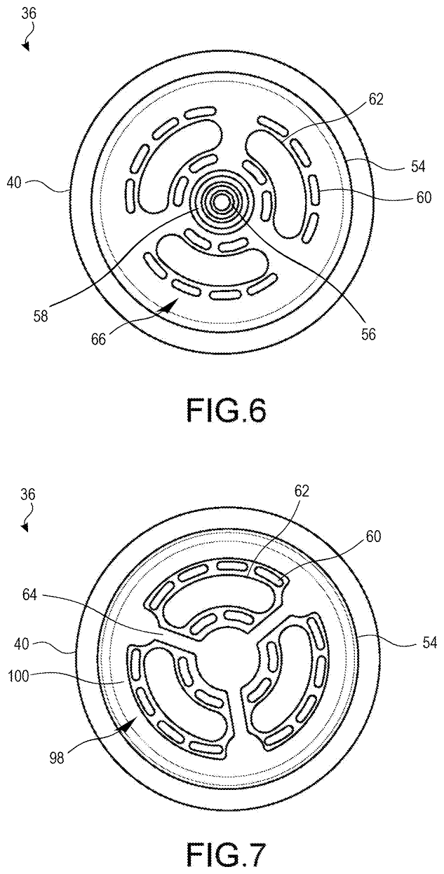

FIG. 6 illustrates a top view of an example plunger base 36, while FIG. 7 illustrates a bottom view thereof. FIGS. 6 and 7 are described concurrently and not all components described are visible in both FIG. 6 and FIG. 7. In the particular example shown, base 36 defines three valve receivers 62, that are a curved stadium-shape with the sides of the stadium shapes are concentric with an outer perimeter of base 36. In other examples, greater or fewer than three valve receivers 62 may be defined in the base 36, and other shapes thereof are contemplated. In the particular example shown, base 36 defines four flow-through openings 60 between an outer edge of each valve receiver 62 and the outer perimeter 54 of base 36, and two flow through openings 60 between an inner edge of each valve receiver 62 and an inner perimeter 56 of base 36. The flow through openings 60 as shown are a curved stadium-shape, similar to the valve receivers 62. In other examples, a greater or fewer number of flow-through openings 60 may be utilized, along with flow-though openings having different shapes. In the particular example shown, three radial spokes 64 extend from a center of bottom surface 98 toward the outer perimeter 54 (perpendicular to axis X) of base 36. In other examples, a greater or fewer number of radial spokes 64 may be present. Radial spokes 64 may terminate at an outer end at a screen support ring 100 that may be a ring around the outer perimeter 54 of base 36 on the bottom surface 98. Radial spokes 64 may be spaced and located such that the openings between them align with the flow passages defined by base 36 (flow through openings 60 and valve receivers 62) and do not impede the flow paths created by the flow passages.

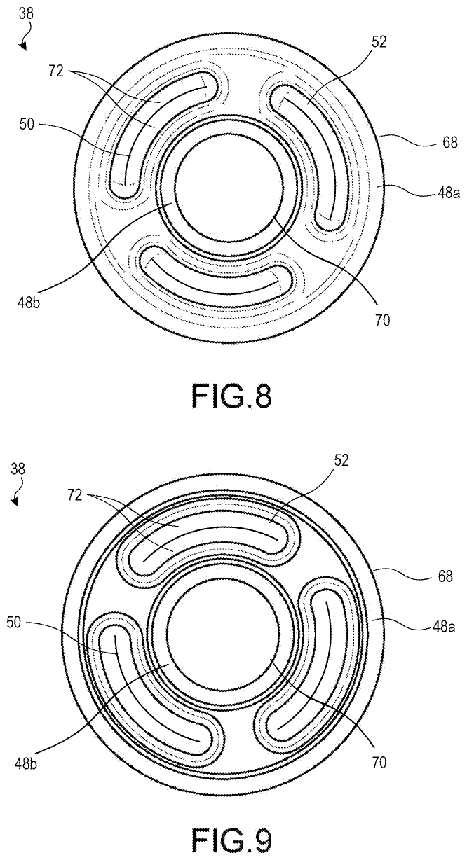

FIG. 8 illustrates a top view of an example valve system 38, while FIG. 9 illustrates a bottom view thereof. FIGS. 8 and 9 are described concurrently and not all components described are visible in both FIG. 8 and FIG. 9. Outer perimeter 68 of valve system 38 may be circular and concentric with an inner perimeter 70 of the valve system 38. Outer portion 48a of first valve 48 may circumscribe valve system 38 along outer perimeter 68. Inner portion 48b of first valve 48 may circumscribe valve system 38 along inner perimeter 70. Outer portion 48a of first valve 48 and inner portion 48b of first valve 48 may comprise selectively deflectable, flexible flaps that allow flowthrough the respective valves when the flexible flaps are open.

In the particular example shown, valve system 38 includes three second valves 52 that are a curved stadium-shape, similar to the valve receivers 62. In other examples, greater or fewer number of second valves 52 may be utilized, along with second valves different shapes. Each of the second valves 52 may include a second valve opening 50 including an arc-shaped slit through the material of the second valve 52, in a central, lower portion of the second valve 52. The slit forming the second valve opening 50 may create a pair of flexible lips 72 that define a flow path through the second valve 52 when the pair of flexible lips 72 are open. Valve system 38 may comprise a flexible material. In some examples, valve system 38 includes silicone, rubber, or other suitable flexible material or combination of materials.

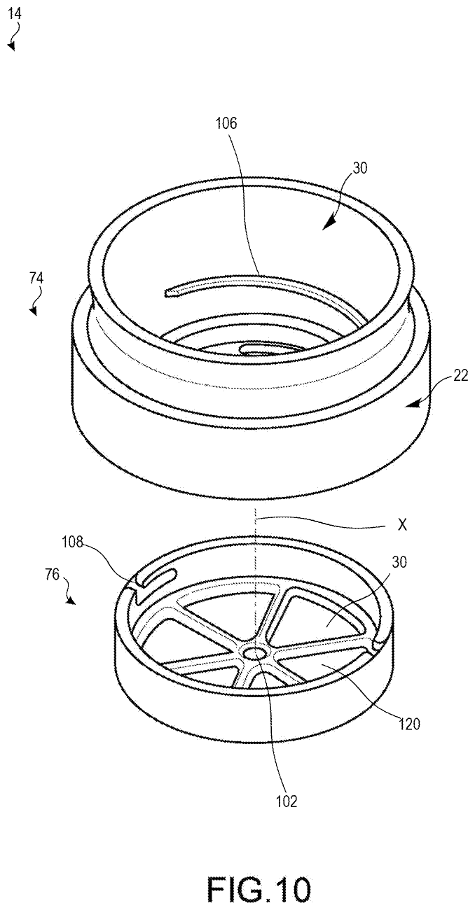

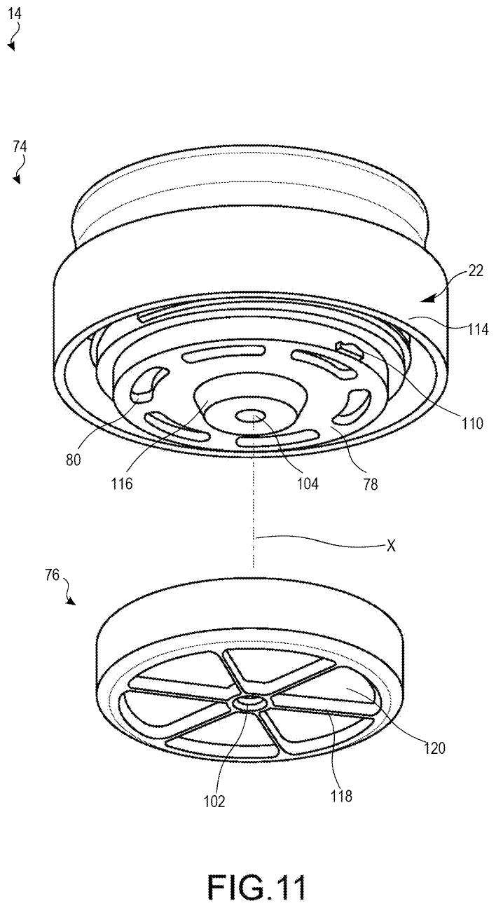

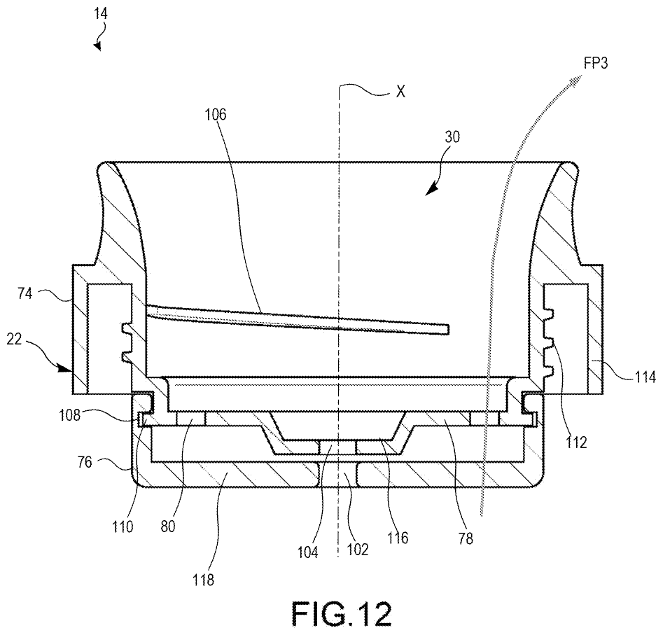

FIGS. 10 and 11 illustrate top and bottom exploded perspective views, respectively, of a drinking assembly 14, while FIG. 12 illustrates a cross-sectional view thereof. FIGS. 10, 11, and 12 are described concurrently and not all components described are visible in every one of those figures. Drinking assembly 14 may include a spout portion (an upper drinking portion) 74 removably attached to a filter portion 76. Spout portion 74 may include one or more projections 110 that are configured to engage with slots 108 on the filter portion 76. For example, projections 110 may be inserted into slot 108 and then twisted to lock into place, or may utilize a snap-fit or press-fit connection.

Spout portion 74 may be configured to removably attach to beverage container 18, for example, via a connection feature 112 such as a threaded connection that engages with connection portion 44 of beverage container 18, as depicted in FIGS. 1-3. Spout portion 74 may include threads 106 or other connection features for removable connection with cap mating surface 28 of cap 12, as depicted in FIGS. 1-3. Spout portion 74 may include an outer wall projection 114, the external surface 22 of which may align with external surface 24 of beverage container 18 and/or external surface 20 of cap 22. Spout portion 74 may include a round perforated plate 78 centered on axis X. Perforated plate 78 may define one or more fluid passage openings 80 that have a curved stadium-shape; here, six are depicted. In other examples, a greater or fewer number of fluid passage openings 80 may be utilized, and other shapes are contemplated. Perforated plate 78 may define a recess 116 that may be aligned with the axis X. Recess 116 may project below the surface of perforated plate 78 and is configured to receive at least a portion of handle 34. Recess 116 may have a same shape as handle 34. In some examples, recess 116 may be cylindrical, frustoconical, conical, or other suitable shape. Spout portion 74 may include an inner wall 30 that flares outward toward the top and is substantially vertical at its bottom where it intersects perforated plate 78. Aligned center opening 104 and center opening 102, in the perforated plate 78 and filter portion 76, respectively, are configured such that the rod 32 may pass or slide therethrough and such that the rod 32 is centered within the beverage container 18 on the axis X.

Filter portion 76 includes a filter 120 in the form of a screen, or a woven or perforated plate or disc that may be manufactured of a metal, polymer, or other suitable material. In other examples, filter 120 may comprise a porous material such as a polymer filter or paper filter. The openings or perforations of filter 120 may be configured so as to allow a suitable flow of liquid to pass through, and to prevent coffee grounds or other beverage precursors or particulates from passing through. Filter 120 may be disc-shaped and have a smaller circumference than that of filter portion 76 and may have an opening at its center aligned with center opening 102 such that the rod 32 may pass or slide therethrough and such that the rod 32 is centered within the beverage container 18 on the axis X. Filter 120 may be supported by one or more radial filter support spokes 118 of filter portion 76. In the particular example shown, six radial filter support spokes 118 extend radially from center opening 102 toward the outer perimeter of filter portion 76 (perpendicular to axis X). In other examples, greater or fewer than six filter support spokes 118 may be present. Filter support spokes 118 may be spaced and located such that the openings between them expose enough of filter 120 to allow for satisfactory flow of liquids through filter 120. Referring to FIG. 12, liquid exits the beverage container via a flow path FP3 formed by the spout portion 74 (e.g., through fluid passage openings 80) and the filter portion 76 (e.g., through filter 120).

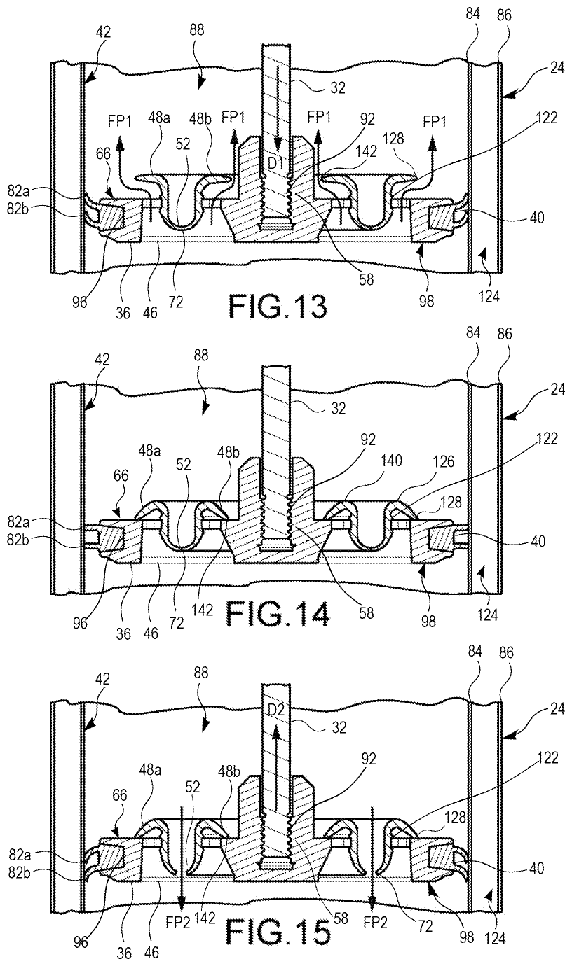

FIG. 13 illustrates a cross-sectional view of the plunger 16 inserted into the beverage container 18, showing the plunger 16 moving in a downward direction and showing outer portion 48a and inner portion 48b of first valve 48 in an open position and second valves 52 in a closed position. FIG. 14 illustrates a cross-sectional view of the plunger 16 inserted into the beverage container 18, showing the plunger 16 in a stationary position and showing the outer portion 48a and inner portion 48b of first valve 48 in a closed position and the second valves 52 in a closed position. FIG. 15 illustrates a cross-sectional view of the plunger 16 inserted into the beverage container 18, showing the plunger 16 moving in an upward direction and showing the outer portion 48a and inner portion 48b of first valve 48 in a closed position and the second valves 52 in an open position. FIGS. 13, 14, and 15 are described concurrently and not all components described are visible in every one of those figures.

A liquid (for example, hot water) may be placed into the beverage container 18. A beverage precursor (for example, coffee grounds or tea leaves) may be placed into the beverage container before or after the liquid. A plunger system 16 is secured to the beverage container 18. Referring to FIG. 13, the plunger 16 is slid in a first direction D1 (for example, downwards along axis X toward the bottom of the beverage container 18). In some examples, a user may wait a period of time after placement of the liquid and/or beverage precursor to allow the beverage to be prepared (e.g., to steep or infuse). As the plunger 16 is moved in the first direction D1, the gasket 40 may seal against the inner sidewall 84 of the beverage container 18 to prevent liquid or beverage precursor from passing between the gasket 40 and the inner sidewall 84. The gasket 40 may include a pair of flexible protrusions 82a, 82b in slidable contact with the inner surface 42 of the inner sidewall 84 that deflect upward against the inner sidewall 84 as the plunger 16 is moved in the first direction D1.

Movement of the plunger 16 in the first direction D1 causes the flexible inner 48b and outer 48a portions of the first valve 48 to deflect away from the base 36 into a first valve flow-open position. In this first valve flow-open position, the bottom edge 128 of the outer portion 48a of the first valve 48 and the bottom edge 142 of the inner portion 48b of the first valve 48 are deflected away from an upper surface 66 of the base 36. Liquid (for example, prepared beverage) may flow upwards through screen 46 and along a first flow path FP1, through the flow through openings 60 of base 36, as allowed by the flow-open position of the outer portion 48a and inner portion 48b of first valve 48. During movement of the plunger 16 in the first direction D1, the flexible lips 72 of the second valve(s) 52 may be deposed in a second valve flow-closed position, to form a seal between the flexible lips 72.

In FIG. 14, the plunger 16 is stationary. The gasket 40 may seal against the inner sidewall 84 of beverage container 18. The pair of flexible protrusions 82a, 82b may be deflected upward, deflected downward, or may be substantially undeflected (horizontal with relation to axis X). While plunger 16 is stationary, the bottom edge 128 of the outer portion 48a of the first valve 48 and the bottom edge 142 of the inner portion 48b of the first valve 48 seal against upper surface 66 of the base 36 in a first valve flow-closed position. While plunger 16 is stationary, the flexible lips 72 of the second valve(s) 52 may also be deposed in a second valve flow-closed position, to form a seal between the flexible lips 72. Because both the first valve 48 (outer portion 48a and inner portion 48b) and the second valve 52 are deposed in their closed positions, there are no open flow paths for liquid to flow through the plunger 16. This prevents the liquid above the plunger 16 from coming into contact with liquid and/or solids below the plunger 16 (for example, to prevent over-brewed coffee or over-steeped tea). These seals may remain in place regardless of the position of the beverage apparatus 10 (for example, if a user tilts/tips the beverage apparatus 10 to drink the prepared liquid, the seals may allow only the liquid sealed above the plunger 16 to exit via FP3).

The plunger 16 may be slid in a second direction D2 (for example, upward along axis X, as a user would move the plunger 16 to remove it from the beverage container 18). Refer to FIG. 15, as the plunger 16 is moved in the second direction D2, the gasket 40 may seal against the inner sidewall 84 of the beverage container 18. The pair of flexible protrusions 82a, 82b may deflect downward against the inner sidewall 84 as the plunger 16 is moved in the second direction D2. Movement of the plunger 16 in the second direction D2 causes the flexible lips 72 of the second valve 52 to deflect away from each other to open into a second valve flow-open position. Liquid (for example, prepared beverage) may flow along a second flow path FP2, through the second valve flow-open position of the flexible lips 72 of the second valve 52, and then downwards through screen 46. During movement of the plunger 16 in the second direction D2, the bottom edge 128 of the outer portion 48a of the first valve 48 and the bottom edge 142 of the inner portion 48b of the first valve 48 seal against upper surface 66 of the base 36 in a first valve flow-closed position.

FIGS. 13-15 further illustrate additional features of the beverage apparatus 10. The flexible flap of the outer portion 48a of first valve 48 connects at a top edge 126 to valve system 38, ends at a bottom edge 128 along the outer perimeter 68 of the valve system 38, and contacts valve system 38 along bottom edge 128. The flexible flap of inner portion 48b of first valve 48 connects at a top edge 140 to valve system 38, ends at a bottom edge 142 along the inner perimeter 70 of the valve system 38, and contacts valve system 38 along its bottom edge 142. In some examples, the base 36 is circular, and bottom edge 128 and/or bottom edge 142 are at least partially concentric with the perimeter of the base 54. The one or more second valves 52 may be U-shaped in cross-section and may protrude downward from the valve system 38.

Inner sidewall 84 of beverage container 18 may be separated from an outer sidewall 86 of beverage container 18, forming a void volume 124 therebetween. The void volume 124 may be air-filled, under a vacuum, or may contain an insulative material. The void volume 124 may insulate the beverage container 18 so that a hot liquid will retain heat and a cold liquid will remain cold and may maintain the external surface 24 of the beverage container 18 at a temperature comfortable for a user to handle. Each of the one or more second valves 52 of the valve system 38 fits within each of the valve receivers 62 and may be removably connected to the base 36 by one or more detents 122 around the outer perimeter of each second valve 52.

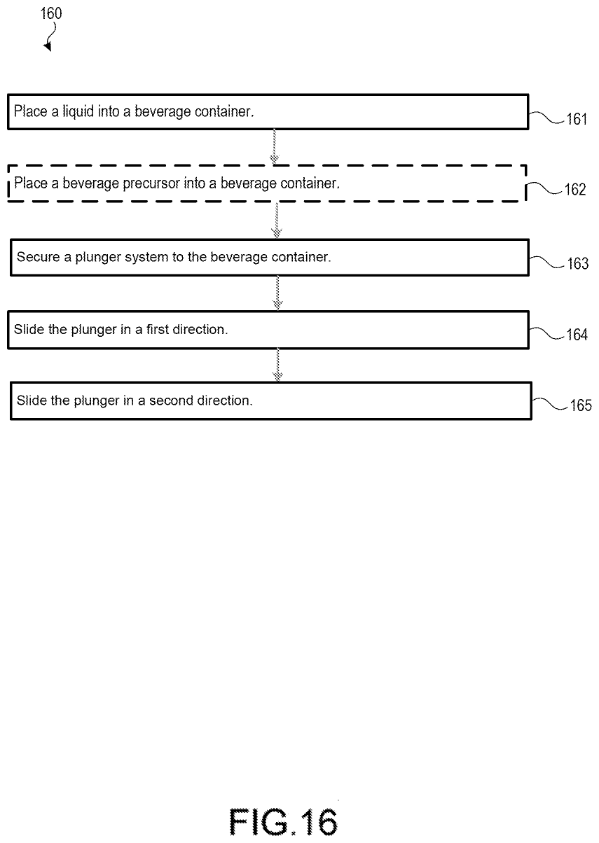

FIG. 16 illustrates a method 160 for separating particulate matter from a liquid. At operation 161, a liquid is placed into a beverage container. At optional operation 162, a beverage precursor may be placed into the beverage container. Optional operation 162 may occur before or after operation 161, but before operation 163. A plunger system is secured to the beverage container in operation 163. At operation 164, the plunger is slid in a first direction, causing a first flexible portion of a first valve to deflect away from a base into a first valve flow-open position, and a second flexible portion of a second valve to be deposed in a second valve flow-closed position, the second flexible portion comprising a pair of lips, wherein the pair of lips form a first seal when the second flexible portion is in the second valve flow-closed position. At operation 165, the plunger is slid in a second direction, causing the second flexible portion of the second valve to open into a second valve flow-open position, wherein the pair of lips deflect away from each other when the second flexible portion is in the second valve flow-open position, and the first flexible portion of the first valve to form a second seal against the base into a first valve flow-closed position. The first flexible portion and the second flexible portions, when positioned in their respective first valve flow-open position (operation 164) and second valve flow open position (operation 165), are configured to allow the passage of liquid.

In accordance with principles of this disclosure, materials of construction for the beverage apparatus 10 and its components as described herein include materials that are compatible with the environment, beverages, cleaning and sanitizing considerations, and use of beverage apparatus 10.

For the purposes of this application, terms such as “upper,” “lower,” “upward,” and “downward” are intended to be descriptive with reference to and in relation to the orientation shown in the Figures for clarity, but the examples as practiced and included in the scope of the claims may include examples where the systems and devices are in a different orientation.

While particular uses of the technology have been illustrated and discussed above, the disclosed technology can be used with a variety of environments in accordance with many examples of the technology. The above discussion is not meant to suggest that the disclosed technology is only suitable for implementation within the environments shown and described above. For examples, while certain technologies described herein were primarily described in the context of drinkable beverages, technologies disclosed herein may be applicable to filtration, separation, or purification generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or operations are disclosed only as illustrative aspects. The scope of the technology is defined by the following claims and any equivalents therein.

What is claimed is:

1. A plunger for a beverage container, the plunger comprising:
a base defining a flow passage;
a rod connected to the base;
gasket disposed about a perimeter of the base; and
a valve system connected to the base and disposed at least partially within the flow passage, wherein the valve system comprises:
a first valve comprising a first flexible portion selectively deflectable away from the base, from a first valve flow-closed condition to a first valve flow-open condition; and
a second valve comprising a second flexible portion, wherein the second flexible portion is selectively openable from a second valve flow-closed condition to a second valve flow-open condition.

2. The plunger of claim 1, further comprising a screen disposed adjacent the base.

3. The plunger of claim 1, wherein the valve system is removably connected to the base.

4. The plunger of claim 3, wherein the valve system further comprises a detent for removably connecting the valve system to the base.

5. The plunger of claim 1, wherein the first valve forms a seal against the base when the first flexible portion is in the first valve flow-closed position.

6. The plunger of claim 1, wherein the base is circular, and at least a portion of the first valve defines an edge at least partially concentric with the perimeter of the base.

7. The plunger of claim 1, wherein the second valve further comprises a pair of centrally-disposed flexible lips.

8. The plunger of claim 1, wherein the valve system comprises a single first valve and a plurality of second valves.

9. The plunger of claim 1, wherein the first valve and the second valve comprise a unitary part.

10. The plunger of claim 1, wherein the first flexible portion comprises at least one flexible flap, wherein the at least one flexible flap circumscribes the valve receiver, and wherein the base comprises a plurality of flow-through openings disposed below the at least one flexible flap.

11. An apparatus comprising:
a beverage container comprising a sidewall comprising an inner surface at least partially defining an interior container volume; and
a plunger slidingly disposed in the interior container volume, comprising:
a base defining a flow passage;
a rod connected to the base;
a gasket disposed about a perimeter of the base, the gasket forming a seal against an inner surface of the sidewall; and
a valve system connected to the base and disposed at least partially within the flow passage, wherein the valve system comprises:
a first valve comprising a first flexible portion selectively deflectable away from the base, from a first valve flow-closed condition to a first valve flow-open condition; and
a second valve comprising a second flexible portion, wherein the second flexible portion is selectively openable from a second valve flow-closed condition to a second valve flow-open condition.

12. The apparatus of claim 11, wherein the beverage container further comprises an outer surface, the outer surface and inner surface defining an insulating volume therebetween.

13. The apparatus of claim 11, wherein the gasket comprises a pair of flexible protrusions in slidable contact with the inner surface of the sidewall.

14. The apparatus of claim 11, further comprising:
a perforated plate having a first opening configured to allow passage of the rod, the perforated plate being removably connected to an upper end of the beverage container; and
a filter supported by the perforated plate.

15. The apparatus of claim 14, wherein the perforated plate is configured to slidably receive the rod and is further configured to center the rod within the beverage container, and wherein the perforated comprises a plurality of second openings configured to allow the passage of fluid.

16. The apparatus of claim 11,
wherein during a first sliding movement of the plunger, the first flexible portion of the first valve is deposed in the first valve flow-open position, and the second flexible portion of the second valve is disposed in the second valve flow-closed position,
wherein during a second sliding movement of the plunger, the second flexible portion of the second valve opens into the second valve flow-open position, and the first flexible portion of the first valve is deposed in the first valve flow-closed position, and
wherein during a still position of the plunger, the first flexible portion of the first valve remains in the first valve flow-closed position, and the second flexible portion of the second valve remains in the second valve flow-closed position.

17. The apparatus of claim 16, wherein the first flexible portion of the first valve deflects away from the base when the first flexible portion of the first valve is deposed in the first valve flow-open position.

18. The apparatus of claim 16, wherein the second flexible portion comprises a pair of lips, and wherein the pair of lips form a seal when the second flexible portion is deposed in the second valve flow-closed position.

19. The apparatus of claim 16, wherein the wherein the second flexible portion comprises a pair of lips, and wherein the pair of lips deflect away from each other when the second flexible portion is in the second valve flow-open position.

20. The apparatus of claim 16, wherein the first flexible portion of the first valve forms a seal against the base when the first flexible portion of the first valve is deposed in the first valve flow-closed position.

21. The apparatus of claim 11, further comprising a cap,
wherein the cap is removably connected to an upper end of the beverage container, and
wherein the cap forms a leak-proof seal around a perimeter of the sidewall.

22. A method, comprising:
placing a liquid into a beverage container;
securing a plunger system to the beverage container;
sliding the plunger in a first direction, causing:
a first flexible portion of a first valve to deflect away from a base into a first valve flow-open position, and
a second flexible portion of a second valve to be deposed in a second valve flow-closed position, the second flexible portion comprising a pair of lips, wherein the pair of lips form a first seal when the second flexible portion is in the second valve flow-closed position; and
sliding the plunger in a second direction, causing:
the second flexible portion of the second valve to open into a second valve flow-open position, wherein the pair of lips deflect away from each other when the second flexible portion is in the second valve flow-open position, and
the first flexible portion of the first valve to form a second seal against the base into a first valve flow-closed position.

23. The method of claim 22, wherein the first flexible portion and the second flexible portions, when in their respective first valve flow-open position and second valve flow open position, are configured to allow the passage of liquid.

24. The method of claim 22, further comprising:
prior to securing the plunger system to the beverage container, placing a beverage precursor into the beverage container.
